(19) United States
(12) Patent Application Publication
(10) Pub. No.: US 2019/0134912 A1
(43) Pub. Date: May 9, 2019

(54) SETTING PRINTING DISTANCES

(71) Applicant: HEWLETT-PACKARD DEVELOPMENT COMPANY, L.P., Houston, TX (US)

(72) Inventors: Fernando Juan, Sant Cugat del Valles (ES); Sergi Culubret, Sant Cugat del Valles (ES); Marius Valles, Sant Cugat del Valles (ES); Gerard Mosquera, Sant Cugat del Valles (ES)

(73) Assignee: HEWLETT-PACKARD DEVELOPMENT COMPANY, L.P., Houston, TX (US)

(21) Appl. No.: 16/095,797

(22) PCT Filed: Jul. 5, 2016
(86) PCT No.: PCT/EP2016/065885

§ 371 Date: Oct. 23, 2018

(51) Int. Cl. B29C 64/393; B29C 64/165; B29C 64/245; B33Y 10/00; B33Y 30/00; B33Y 50/02

(52) U.S. Cl. CPC B29C 64/393; B29C 64/165; B33Y 50/02; B33Y 10/00; B33Y 30/00; B29C 64/245

(57) ABSTRACT

Methods and devices for setting a printing distance in a 3D printing system are disclosed. In one example the method comprises forming a layer of build material below a printing plane and relatively displacing the formed layer of build material with respect to the printing plane until the distance between the formed layer of build material and the printing plane is a desired printing distance.

### BACKGROUND

Additive manufacturing techniques may generate a three-dimensional object on a layer-by-layer basis through the solidification of a build material. In examples of such techniques, build material is supplied in a layer-wise manner and a solidification method may include heating the layers of build material to cause melting in selected regions.

### BRIEF DESCRIPTION

Some non-limiting examples of the present disclosure are described in the following with reference to the appended drawings, in which:

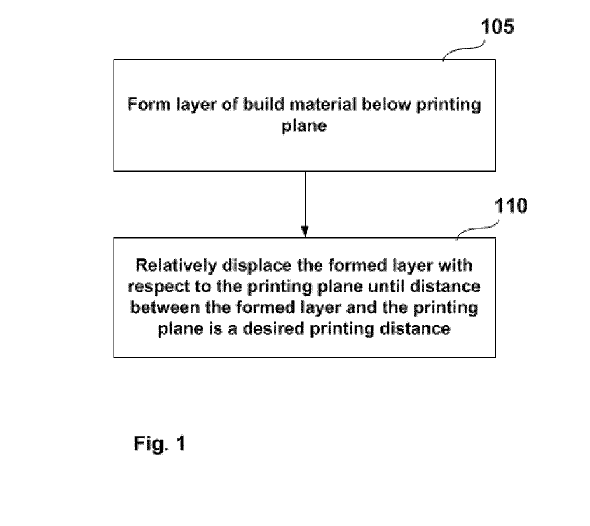

FIG. 1 schematically illustrates a method of setting a printing distance according to an example.

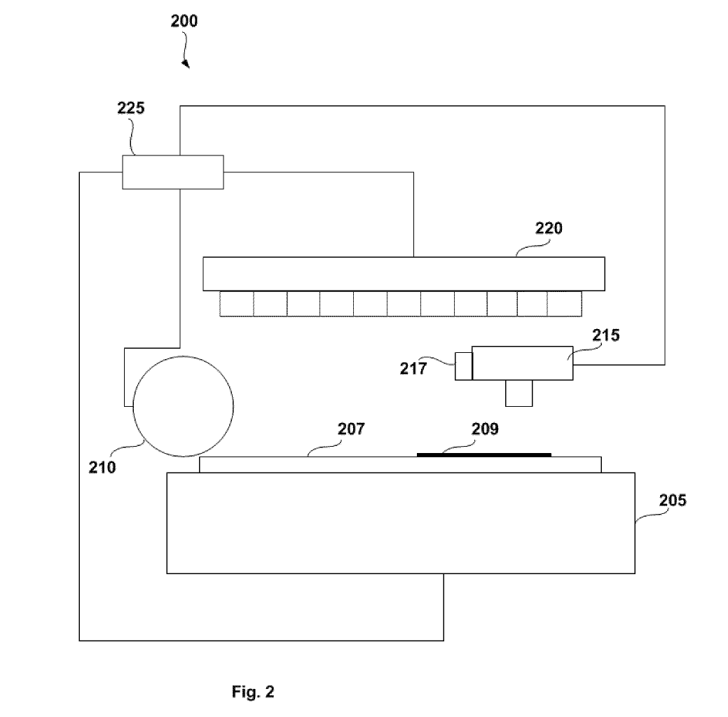

FIG. 2 schematically illustrates a 3D printer according to an example.

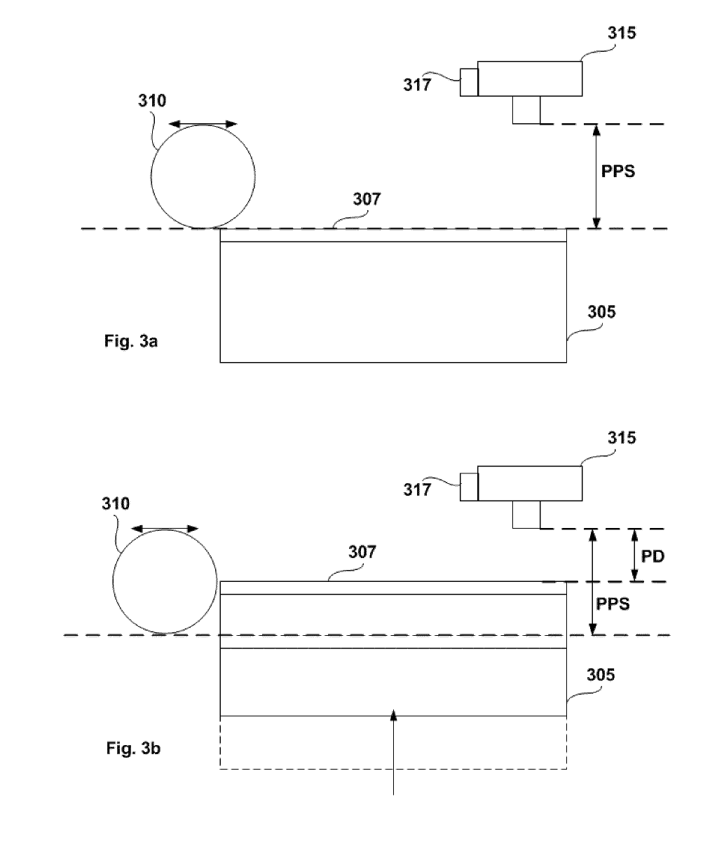

FIG. 3 schematically illustrates a printing sequence according to an example.

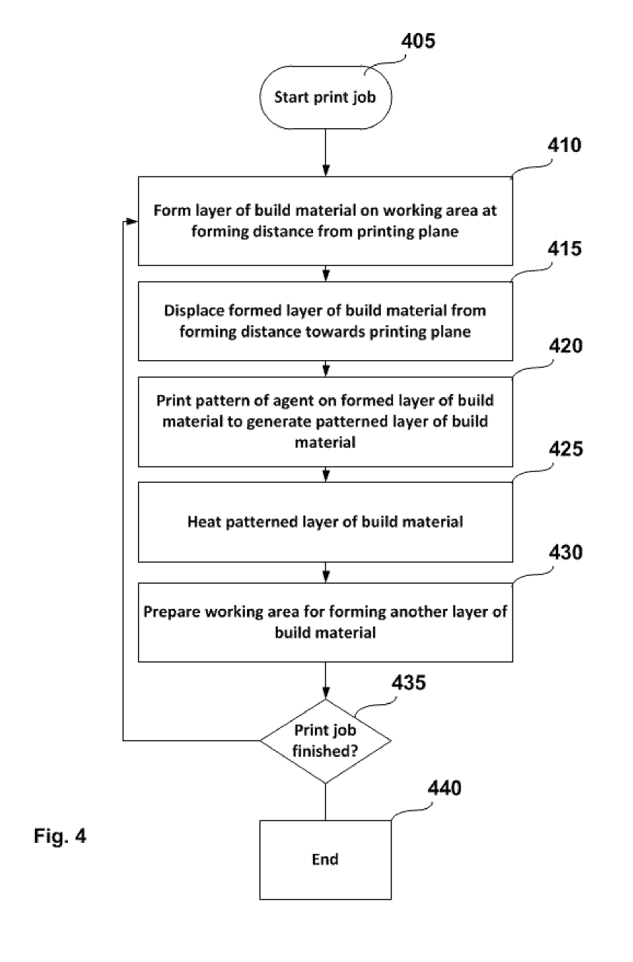

FIG. 4 schematically illustrates a method of printing according to an example.

### DETAILED DESCRIPTION

In 3D printing processes a layer of a build material in the form of a particle material, e.g. powder, is laid down on a working area. Then an agent, e.g. a fusing and/or a detailing agent, is selectively applied. A fusing agent is applied on a material layer where the particles are meant to fuse together. A detailing agent is applied to modify fusing, and create fine detail and smooth surfaces. The work area is subsequently exposed to fusing energy. The process is then repeated until a part has been formed. During a first pass, the working area may be a support platform or bed. Subsequently, the working area may be a previously formed layer of material.

When a formed layer of material is completed, the support platform may move down by a step, for example by a 0.1 mm step, to provide space and volume for a next layer of build material to be formed on top of the previously processed layer. A recoater system may form the next layer of build material. In some examples the recoater system may form a pile of build material at one side of the support platform and then spread this pile over the support platform using a blade or roller. In other implementations the recoater system may comprise a movable hopper to form the layer of build material as the hopper moves over the support platform. The recoater system may define a recoating plane. The recoating plane may be defined by the path of the lower generatrix of the roller or the lower edge of the blade and may match with the plane formed by the upper side of the new layer. This recoating plane is static because it is determined by the position of the recoater system guide.

In some 3D printers an agent may be deposited on the formed layer of material in order to determine the geometry of the built parts layer by layer. This agent is usually delivered by a moving device (or print carriage) which usually is describing a planar movement on a static plane determined by a linear or circular guide. This plane may be called a printing plane, and it may be defined by the lower end of the moving device which is delivering the agent. In some examples the moving device may comprise a printhead with nozzles. In such cases, the printing plane may be defined by the lower surface of the printhead or the nozzles.

The distance between the recoating plane and the printing plane may be called Powder to Printhead Space (PPS) if the formed layer of material is powder and the agent is delivered by a printhead. In other cases the term Printing to Recoating Space (PRS) may be more suitable. For the purpose of this disclosure the terms PPS and PRS may be used indistinguishably.

The PPS distance is, by definition, a fixed distance. Therefore, printing systems using a fixed PPS rely on tight mechanical component tolerances of the guides of the recoater system, of the guides of the print carriage and of the structural elements between said guides. Furthermore, printing accuracy may be a factor of the distance from where the agent is delivered. A fixed PPS that relies on mechanical component tolerances may thus limit the printing accuracy. Furthermore, air turbulence may depend on the speed of the print carriage and the space between the print carriage that delivers the agent and the layer of build material. A fixed PPS may not allow control of air turbulence for different types of materials. If the PPS distance is larger than an optimum distance then the agent deposition from the printing plane on the build material may not be accurate, for example as the drops may fall from a high distance. For example, for a PPS of 2.3 mm an acceptable tolerance may be up to ±0.3 mm. If the mechanical component tolerances produce a PPS higher than the acceptable range, i.e. higher than 2.6 mm, the deposition may not be as accurate as expected. If the PPS distance is lower than the optimum distance then agent depositing may be more accurate, but, as the fusing temperature of different build materials may not be the same, the temperature of the build material may be high, and it may affect the printhead when the printhead moves/is positioned over a hot print bed. Furthermore, the movement of the print carriage over the powder during printing may displace the air above the print bed and generate lifting forces that may affect the uniformity of the formed build material on the print bed.

Methods and mechanisms are proposed that provide a variable distance between the printing plane and the formed layer of material. Herein after this distance will be called a printing distance.

FIG. 1 schematically illustrates a flow diagram of a method of setting a printing distance in a 3D printing system according to an example. In block 105, a layer of build material may be formed below a printing plane. This layer may be formed by a recoater system. If this is a first layer of build material it may be formed on a support platform. Otherwise it may be formed on a previously formed layer of build material. In block 110, the formed layer of build material may be relatively displaced with respect to the printing plane. In some examples, relative displacing may comprise moving the print bed, and consequently the formed layer of build material, towards or away from the printing plane. In other examples, relative displacing may comprise moving the printing plane towards or away from the formed layer of build material. The relative displacing may continue until the distance between the formed layer of build material and the printing plane is a desired printing distance. The desired printing distance may be a factor of characteristics of the build material or build material type and/or of a desired printing accuracy. In some examples, when relatively displacing, it may be checked if the distance between the formed layer of build material and the printing plane is equal to the desired printing distance. If the answer is no, the relative displacing may continue. Otherwise, the relative displacing may stop. When the printing distance is set, an agent may be printed on the formed layer of build material. Other events may take place before or after agent printing, such as the preheating of the print bed. Furthermore, even if a desired printing distance is set, agent printing may not take place as a layer may remain unprinted. This may be the case when various 3D objects may be 3D printed using one print job.

FIG. 2 schematically illustrates a 3D printer according to an example. 3D Printer 200 may comprise a support platform 205, a recoater system 210, a print carriage 215, a heating structure 220, a controller 225 and fusing element 217. In some examples the heating structure and the fusing element may be included in one structure and provide pre-heating and fusing energy. The fusing element 217 may be in the form of a fusing lamp and provide fusing energy. However, other types of fusing elements providing fusing energy may exist. The controller may be coupled to and control the function of the printing platform 205, the recoater system 210, the print carriage 215, the heating structure 220 and the fusing element. During operation, the controller 225 may control the recoater 210 to deposit a layer of build material 207 on the support platform 205. Then the controller 225 may instruct the support platform 205 to move with respect to, e.g. towards, the print carriage 215. Alternatively, the controller 225 may control the print carriage 215 to move the support platform 205 to a desired position so that the distance between the formed layer of build material 207 and the print carriage 215 is the desired printing distance. Then the controller may instruct the print carriage 215 to deposit a pattern of agent 209 on the formed layer of build material 207. When the agent 209 has been deposited, the controller may instruct the print carriage 215 to move away (e.g. to displace horizontally) and may then instruct the fusing element 217 to provide fusing energy to the patterned layer, i.e. to the build material that is partially covered by the agent 509.

FIG. 3A and 3B schematically illustrate a printing sequence according to an example. In FIG. 3A a new layer of build material 307 may be formed on support platform 307 by recoater system 310. After the layer forming or spreading stage, the distance between the formed layer of build material 307 and the printing plane, defined as the plane of the print carriage 315 closer to the formed layer of build material 307, may be called PRS. However, printing from the print carriage 315 may not start at this PRS distance. As shown in FIG. 3B, the support platform 305 may be displaced relative to, e.g. towards, the printing plane until a new distance, the printing distance PD is reached. As shown in FIG. 3B, the support platform 305 may be displaced while the recoater system 310 may remain at the previous position. When the distance between the printing plane and the formed layer of build material 307 is the printing distance PD, then the print carriage 315 may start depositing a pattern of an agent on the formed layer. The fusing element 317 may then provide fusing energy to the patterned layer.

FIG. 4 schematically illustrates a method of printing according to an example. In block 405, a 3D printer may start processing a print job. Then in block 410, a new layer of build material may be formed on a working area at a forming distance from a printing plane. In block 415, the formed layer of build material may be displaced from the forming distance towards the printing plane. In block 420, a pattern of agent may be printed on the displaced formed layer of build material. In block 425, the patterned layer of build material may be heated, i.e. fusing energy may be applied to the patterned layer, to cause portions of the build material on which fusing agent was printed to fuse. In block 430, the working area may be prepared for forming another layer of build material. Preparing the working area may comprise moving the working area to a new forming distance. In decision box 435, a check may be performed as to whether the print job has finished. If this is the case then the process may end. Otherwise the printing method may continue in block 410, with forming another layer of build material on top of the new working area which includes the fused layer of build material.

The example implementations discussed herein allow for a variable printing distance between the working area and the print carriage of a 3D printing system. For a certain working area, this may allow for higher agent deposition accuracy where the optimum printing distance is less than the fixed PPS distance, and for less air turbulence where the optimum printing distance is higher than the fixed PPS distance. Thus, they may improve the quality of a 3D printed object.

Although a number of particular implementations and examples have been disclosed herein, further variants and modifications of the disclosed devices and methods are possible. For example, not all the features disclosed herein are included in all the implementations, and implementations comprising other combinations of the features described are also possible. As such, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. A method of setting a printing distance in a 3D printing system, comprising:
forming a layer of build material below a printing plane;
relatively displacing the formed layer of build material with respect to the printing plane until the distance between the formed layer of build material and the printing plane is a desired printing distance.

2. The method according to claim 1, further comprising printing a agent on the formed layer of build material when the desired printing distance is set.

3. The method according to claim 1, wherein relatively displacing the formed layer of build material comprises displacing the formed layer of build material.

4. The method according to claim 1, wherein relatively displacing the formed layer of build material comprises displacing the printing plane.

5. The method according to claim 1, further comprising determining the desired printing distance.

6. The method according to claim 5, wherein determining the desired printing distance comprises
identifying a printing accuracy; and
identifying the printing distance associated with the identified printing accuracy.

7. The method according to claim 6, wherein identifying the printing distance associated with the identified printing accuracy comprises retrieving the printing distance value from a memory of a computing apparatus.

8. The method according to claim 6, further comprising calculating the printing distance as a function of the printing accuracy or retrieving the printing distance from a table stored in said memory, said table having printing distances associated with printing accuracies.

9. The method according to claim 5, wherein determining the printing distance comprises:
identifying characteristics of the build material; and
identifying the printing distance associated with the identified characteristics.

10. A method of 3D printing comprising:
forming a layer of build material on a working area at a forming distance form a printing plane;
displacing the formed layer of build material from the forming distance towards the printing plane;
printing a pattern of agent on the displaced formed layer of build material;
applying fusing energy on the patterned layer to cause portions of the build material on which fusing agent was printed to fuse.

11. The method according to claim 10, further comprising moving the working area to a new forming distance.

12. A 3D printer comprising:
a coater to form successive layers of build material on a print bed;
an agent depositor to deposit agent on the layers of build material, the agent depositor defining a printing plane;
a fusing element to provide energy to cause portions of the build material on which fusing agent was printed to fuse;
a controller, to:
control the coater to form a layer of build material on a working area of the print bed;
displace the print bed towards the agent depositor plane;
control the agent depositor to print a pattern of agent on the displaced formed layer of build material to generate a fusing layer of build material;
control the fusing element to apply fusing energy to the layer of build material;
prepare the working area for forming another layer of build material.

13. The 3D printer of claim 12, wherein the print bed comprises an elevation mechanism controllable by the controller.

14. The 3D printer of claim 12, further comprising a memory, said memory comprising printing distances, each printing distance associated with a printing accuracy and a build material,
wherein the controller is to identify a printing distance as a function of the build material and an identified accuracy and displace the print bed towards the fusing agent depositor as a function of said identified printing distance.

15. The 3D printer of claim 12, wherein the build material is powder.
